(19) United States
(12) Patent Application Publication
(10) Pub. No.: US 2003/0204498 A1
(43) Pub. Date: Oct. 30, 2003

(54) Customer interaction reporting

(76) Inventor: Bernd R. Lehnert, Neustadt (DE)

Correspondence Address: MARK D. KIRKLAND, Fish & Richardson P.C., 3300 Dain Rauscher Plaza, 60 South Sixth Street, Minneapolis, MN, 55402, US

(21) Appl. No.: 10/157,864

(22) Filed: May 31, 2002

Related U.S. Application Data
(63) Continuation-in-part of application No. 10/134,551, filed on Apr. 30, 2002.

(51) Int. Cl. G06F 7/00

(52) U.S. Cl. 707/3

(57) ABSTRACT

A computer-implemented method of filling out an electronic data gathering form is described. The method includes presenting, during a first session of filling out the data gathering form, a series of queries to a user. Voice responses to the presented queries are received from the user during the first session. During a later second session of filling out the data gathering form, the electronic data gathering form is presented on a visual display with responses completed using the voice responses from the user.

### CROSS-REFERENCE TO RELATED APPLICATION

This application is a continuation-in-part of U.S. application Ser. No. 10/134,551, filed Apr. 30, 2002, and entitled “DATA GATHERING,” the contents of which are incorporated herein by reference.

### BACKGROUND

This disclosure relates to gathering data about interactions with customers.

Many surveys, questionnaires, forms, and other data gathering forms have a format for gathering data using a single particular platform. For example, questionnaires that include both questions and potential replies can be drafted using word processing programs, rendered by printing on paper, and distributed to responders. Once a responder has completed the questionnaire, the responses can be converted into an electronic format using optical character recognition software. Likewise, surveys can be created in HTML format and rendered on a computer screen using a Web browser.

### SUMMARY

In one general aspect, a computer-implemented method of filling out an electronic data gathering form includes presenting, during a first session of filling out the data gathering form, a series of queries to a user. Voice responses to the presented queries are received from the user during the first session. During a later second session of filling out the data gathering form, the electronic data gathering form is presented on a visual display with responses completed using the voice responses from the user.

Implementations may include one or more of the following features. For example, the electronic data gathering form may be a customer interaction report concerning an interaction with a customer, such as a sales visit with the customer. The series of queries may be presented to the user by vocalizing the series of queries to the user, for example, over a telephone network. The voice responses may be received over the telephone network. The received user responses may complete the electronic data gathering form in the second session.

The electronic data gathering form may be presented on the visual display the first time the user logs into a computer system after providing the voice responses. The user need not complete filling out of the electronic survey in the second session. The electronic data gathering form having responses completed using the voice responses and the second session responses from the user may be presented during a later third session of filling out the data gathering form. The responses may be received from a second user during the second session.

In another general aspect, a computer program product may include instructions to cause a processor to receive a first response to a first query in an interaction report over a first platform, receive a second response to a second query in the interaction report over a second platform, and store the interaction report that includes the first response associated with the second response in an electronically accessible format. The interaction report relates to an interaction with a customer. The second platform may be different from the first platform. The computer program product may be tangibly stored on machine readable media.

Implementations may include one or more of the following features. For example, the first response and the second response may be received from a single person, such as, for example, a salesperson reporting about a visit with the customer. The first response may be received over a telephone. The first response may be used to determine a likelihood that the customer will purchase a product. For example, the instructions may cause the processor to determine the likelihood that the customer will purchase the product. The first response may be used to determine if the interaction report should be routed to another. For example, the instructions may cause the processor to route the interaction report as directed by the first response.

The instructions may cause the processor to identify a format-independent portion of the interaction report and a format-dependent portion of the interaction report, and to transform the format-dependent portion of the interaction report for rendition. The format-independent portion may include the first response and the second response. The first response may identify the customer in the interaction. The first response and the second response may be stored separately from the first query and the second query.

The instructions may cause the processor to identify a format-independent portion of the first query and a format-dependent portion of the first query and transform the format-dependent portion of the first query for rendition on the first platform. The format independent portion may include the first response. The instructions may cause the processor to store the first response and the second response as a format-independent portion of the interaction report. The instructions may cause the processor to store a format-dependent portion of the interaction report. The interaction report may be stored in a XML format.

A data gathering form that operates using more than one platform and/or gathers variable sets of data regarding variable subjects may be able to gather and analyze data even in dynamic environments where platforms, and the pertinence of subjects, data, and analyses, change rapidly and from user to user. This is particularly useful when, for example, gathering data about interactions with clients. People, such as salespeople, who interact with clients often lack time to complete interaction reports. By allowing interaction reports to be completed using more than one platform and/or by more than one person, time can be spared and a better understanding of interactions with clients can be achieved.

The details of one or more implementations are set forth in the accompanying drawings and the description below. Other features will be apparent from the description and drawings, and from the claims.

### DESCRIPTION OF DRAWINGS

FIG. 1 is a flow chart of a process for gathering data.

FIG. 2 is a schematic representation of a method for dividing a survey.

FIG. 3 is a schematic representation of a collection of methods for dividing a survey.

FIG. 4 is a schematic representation of a method for translating a survey.

FIG. 5 is a screenshot of an example translation survey.

FIG. 6 is a schematic representation of a method for translating a survey for rendition.

FIG. 7 is a diagram of a display of an example query.

FIG. 8 is a block diagram of a system for gathering data.

FIG. 9 is a schematic representation of an interaction report data gathering form.

FIGS. 10 and 11 are flow charts of processes for gathering data using interaction reports.

Like reference symbols in the various drawings indicate like elements.

### DETAILED DESCRIPTION OF ILLUSTRATIVE EMBODIMENTS

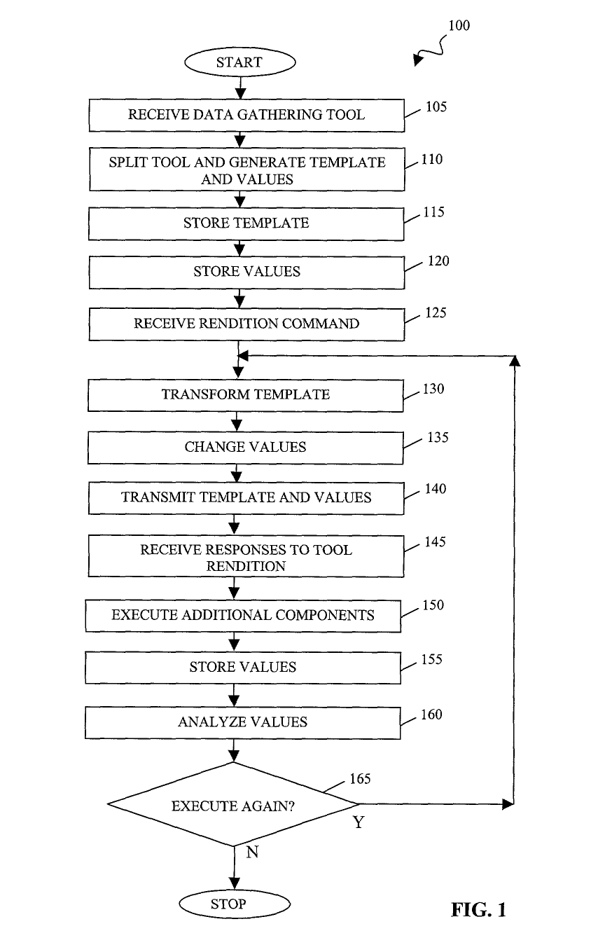

Referring to FIG. 1, a process 100 for gathering data begins with the reception of an electronically-accessible data gathering form such as an electronic query form by a system for gathering data (step 105). The form can be received as a completed construction that includes a collection of predefined queries. Alternatively, the form can be modularly assembled by a user, as discussed further below. The data gathering form may include, for example, queries, potential and default responses to the queries, operating instructions for executing the queries, and display instructions for displaying the queries and responses. The data gathering form may be represented, for example, in an extensible markup language (XML) file.

Once the system has received the data gathering form, the system divides the form into a data gathering form template and data gathering form values (step 110). The system can divide the form by identifying the structures of the form template and the form values. The data gathering form values initially include default responses to the queries in the data gathering form. The data gathering form template includes the remainder of the data gathering form, including query text, layout and presentation parameters, and operations. The system stores the template (step 115) and the values (step 120) separately.

Dividing the data gathering form simplifies translation of the data gathering form values into other human languages or computer formats. In particular, the data gathering form values are format-independent (for example, a logic high or an integer value), whereas the data gathering template may be language-dependent or platform-dependent (for example, ASCII query text may ask if the responder were satisfied with a product or may ask the responder to rank the responder's satisfaction with the product on an integer scale, while a format parameter may specify relative font sizes). By separating data gathering form values from the data gathering form template, the portion of the data gathering form that is translated into other languages or formats is reduced.

At some point in time, the system can receive a rendition command indicating that rendition of the data gathering form is requested (step 125). The rendition command also identifies the platform where the data gathering form is to be executed. Suitable platforms include cellular phones, processor systems like personal computers, software applications such as customer resource management (CRM) applications running on network systems, websites, personal digital assistants (PDAs), and email. Once the rendition platform has been identified, the system transforms the data gathering form template (step 130) and changes the data gathering form values (step 135) for rendition on the platform, and transmits the transformed template and the changed values to a responder's platform (step 140).

A responder's platform integrates the data gathering form template and the data gathering form values into a single data gathering form. The form is rendered by the responder's platform, which, in turn, receives responses to the queries of the data gathering form and returns them to the system. The responder's platform can render the data gathering form by, for example, printing the queries in the data gathering form, displaying the queries in the data gathering form on an electronic display, or vocalizing the queries in the data gathering form over a telephone line. The system receives the responses (step 145), and may additionally call other functions, such as data analysis applications, using the received data (step 150). The responses received during rendition of the data gathering form are stored as the data gathering form values (step 155). The responses may, for example, overwrite the default data gathering form values or be stored subsequently to the default data gathering form values so that a record of change in the responses is maintained. The responses may be stored in a database.

Rendition of the data gathering form may be followed by analysis of the received responses (step 160). Either the platform or the system may perform an analysis using rules or other criteria included in the data gathering form.

For any of a number of reasons, the platform rendering the data gathering form may not complete data gathering. For example, a responder may lack the time needed to respond to every query in a data gathering form, appropriate responses may not yet be available, or data gathering may be interrupted. In view of this, a decision is made as to whether the data gathering form is to be rendered again (step 165). This decision can be based on, for example, the receipt of another rendition command that identifies a different platform. If it is decided that the data gathering form is to again be executed, then the process 100 returns to having the system transform the data gathering form template (step 130) and change the data gathering form values (step 135) for rendition on the new platform.

A survey is class of data gathering form that can be sent to customers or potential customers to determine their opinion about a product or a product offering. For example, a survey may be sent to customers to measure customer satisfaction with a new or potential product version or to receive a trainee evaluation of the quality or content of a training session. In these example scenarios, the customer responses are used for planning, designing, and improving products.

Another class of surveys may be sent to customers to gauge their interest in a product offering. This class of surveys is used in lead evaluation to ascertain the value of a sales opportunity.

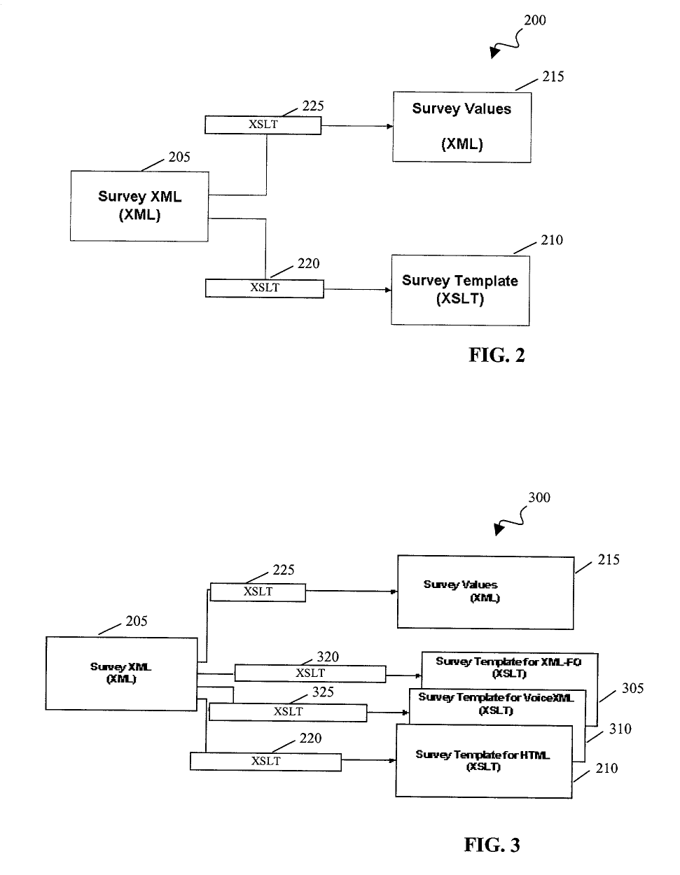

Referring to FIG. 2, a process 200 divides a survey 205 into a survey template 210 and survey values 215. Survey 205 is represented in a XML format. Survey 205 is transformed using a first extensible markup language transformation (XSLT) 220 to provide a XSLT format survey template 210. Survey 205 is transformed using a second XSLT 225 to provide survey values 215 in a XML format.

By dividing survey 205 into a survey template 210 and survey values 215, the translation of survey 205 into other human languages or computer formats is simplified. In particular, only the survey template portion 210 needs to be translated. For example, referring to FIG. 3, a process 300 may extract multiple survey templates 305, 310, and 315 from the survey 205 using XSLTs 320, 325, and 330 that are selected in accordance with a responder's platform. For example, survey 205 may be transformed using a first XSLT 325 to provide an XSLT format survey template 310 for voice platforms like cellular phones. Survey 205 may also be transformed using a second XSLT 320 to provide an XSLT format survey template 315 for, e.g., the creation of portable document format (PDF) surveys. Survey 205 may also be transformed into survey templates having other formats. For example, if the survey 205 is to be executed on a handheld device, the survey may be transformed into a website META language (WML) format. Independent of the transformation of the survey template, transform 225 may be used to extract survey values 215 from survey 205. By separating survey values from survey templates, the portion of the survey that is translated into other languages or formats is reduced.

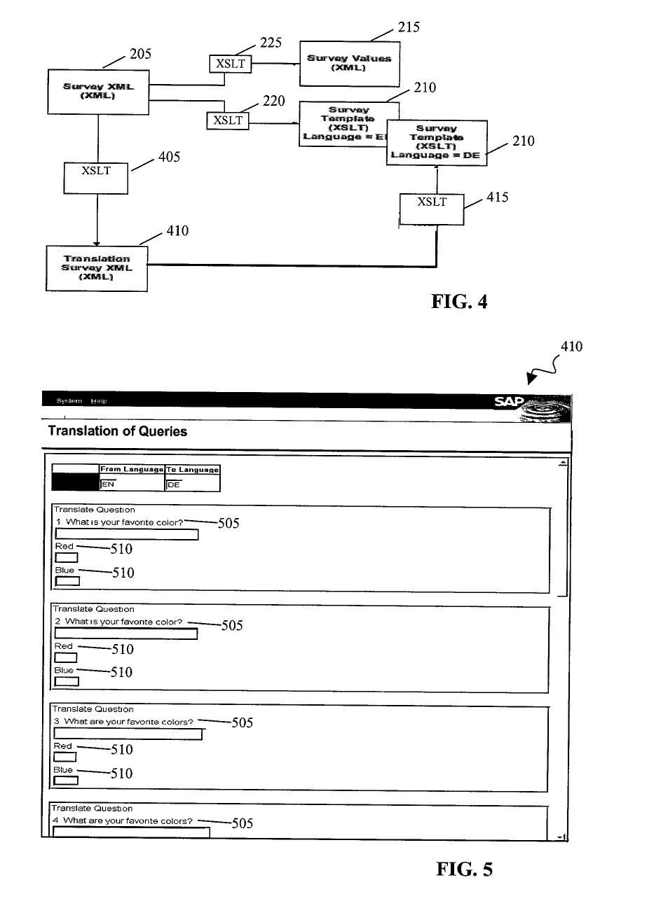

Referring to FIG. 4, a variety of survey templates 210 selected in accordance with a responder's language may also be extracted from survey 205. For example, an inquirer's or a responder's system may use a transformation 405 to extract text from survey 205 to generate a translation survey 410 in XML format. Referring also to FIG. 5, translation survey 410 includes extracted query texts 505 and response text labels 510.

Survey 410 is translated using, e.g., a Web browser or an embedded HTML control. After translation, translation survey 410 is then activated when a system calls a second transformation 415 which generates a translated survey template 210. The translated survey template 210 can be linked or otherwise associated with survey 205.

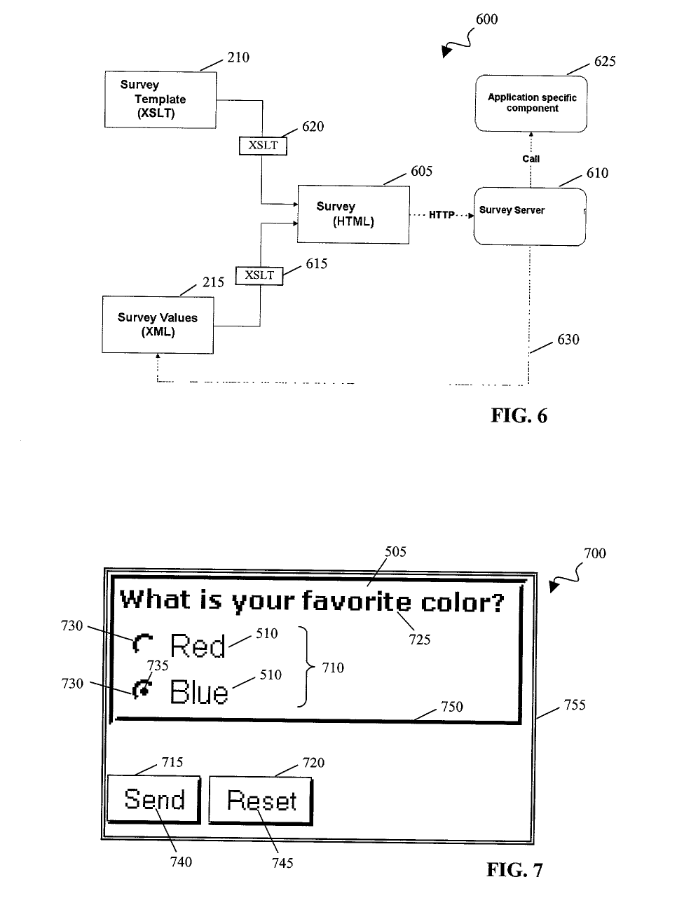

Referring to FIG. 6, a process 600 uses survey template 210 and survey values 215 to produce a hypertext markup language (HTML) survey 605 that can be rendered on a responder's survey server platform 610. Survey template 210 is transformed using an XSLT 615 and survey values 215 are transformed using an XSLT 620 and integrated to provide an HTML survey 605. The responder's platform can transform survey template 210 and survey values 215 to provide HTML survey 605. In addition to queries and potential responses, HTML survey 605 may also include defined typographic styles using, for example, cascading style sheets (CSS).

HTML survey 605 is transmitted using hypertext transfer protocol (HTTP) to the responder's survey server platform 610 where it is rendered by, for example, a Web browser. Alternatively, HTML survey 605 is integrated into an HTML control within another application, such as a SAP™ CRM Online application. The other application may include an application specific component 605 such as, for example, a data analysis form, that is also executed.

After rendition of HTML survey 605, responses by the customer or the potential customer may be returned 630 to the system that acts as the source of the survey using, e.g., HTTP. Once received, survey values 215 may be overwritten or updated to include the responses generated by rendition of HTML survey 605. Since responses are stored in the survey values 215, a responder can respond to an arbitrary number of queries using a first platform, have the results stored, and then later complete the survey and review the earlier responses using a second platform.

Likewise, since the format of the responses in survey values 215 is the same regardless of the language of survey template 210, responses from responders who speak different languages can easily be compared.

Referring to FIG. 7, a query 700 in a data gathering form includes a query text 505, a response input 710, a response submit input 715, and a response reset 720. Query text 505 has various display characteristics 725 including, for example, a font, a size, and a font style. Response input 710 includes a pair of input radio buttons 730 that are each labeled with a response text label 510. Response input 710 also includes a selection indicator 735 that indicates that a particular radio button 730 is the default response or has been selected by a responder. Response submit input 715 includes a text label 740 that identifies the function of response submit input 715 to a responder. Response reset 720 includes a text label 745 that identifies the function of response reset 720 to a responder. Response submit input 715 and response reset 720 operate query 700. Query 700 may also include additional display features 750, 755, such as, for example, borders, shading, and colors. Query 700 can additionally include further inputs position, for example, beneath the submit and response buttons.

TABLE 1

| Type | Style | Description |
|---|---|---|
| SingleChoice | RadioButton | Only one response is requested, the |
| | | options are represented by radio |
| | | buttons |
| SingleChoice | Listbox | Only one response is requested, the |
| | | options are represented in a listbox |
| MultipleChoice | Checkbox | Any number of responses are |
| | | requested, the options are represented |
| | | by checkboxes |
| MultipleChoice | Listbox | Any number of responses are |
| | | requested, the options are represented |
| | | in a listbox |
| YesNo | Checkbox | The requested response is Boolean, the |
| | | options are represented in a checkbox |
| FillIn | Field | The requested response is an input |
| | | field |
| FillIn | Text | The requested response is text |

Referring to Table 1, various types of queries may be included in a data gathering form such as a survey. SingleChoice queries only request one response. MultipleChoice queries request any number of responses, up to and including every potential response. YesNo queries request a Boolean response. FillIn queries request user input.

TABLE 2

| Type | Style | Attributes | Meaning |
|---|---|---|---|
| FillIn | Field | @Size | Displayed field length |
| | | @MaxLength | field length |
| FillIn | Text | @Rows | Number of rows |
| | | @Cols | Number of columns |

Referring to Table 2, additional attributes may be used to identify the length and other size factors of FillIn queries.

TABLE 3
XML snippet defining query 700 of FIG. 7.

Parameters:

1. Name of the query: QuestionId
2. Name of the answer: AnswerId
3. Type of the query: Type
4. Style of the query: Style
5. State of the answer: ReadOnly

<Question QuestionId=“color”>

<QuestionText>What is your favorite color?</QuestionText>
<Answer AnswerId=“a1” Type=“SingleChoice” Style=“Checkbox”

ReadOnly=“false”>

<Item>

<ItemText>Red</ItemText>
<Value>red</Value>

</Item>
<Item>

<ItemText>Blue</ItemText>
<Value Selected=“true”>blue</Value>

</Item>

</Answer>

</Question>
<Event>
<Button>

<Submit Command=“SUBMIT”>Send</Submit>
<Reset>Reset</Reset>

</Button>
</Event>

Referring to Table 3, an illustrative XML snippet defining query 700 of FIG. 7 describes the text and the operation of query 700 independently of the description of other queries or a global description of the survey. Since query 700 is independently defined, a designer is able to modularly assemble a collection of queries to form a survey or other data gathering form. This increases the flexibility of the data collection process. The type of data that is collected can be rapidly adapted to changing or local conditions and the pertinence of subjects, data, and analyses. An inquirer can also iteratively adapt a data gathering form to particular or changing needs.

Furthermore, the structured format of the XML snippet defining query 700 facilitates separation of the survey values and survey template. In particular, since the format-independent response to query 700 is easy to identify within the XML snippet, logic for splitting the survey values the survey template is relatively easy to implement.

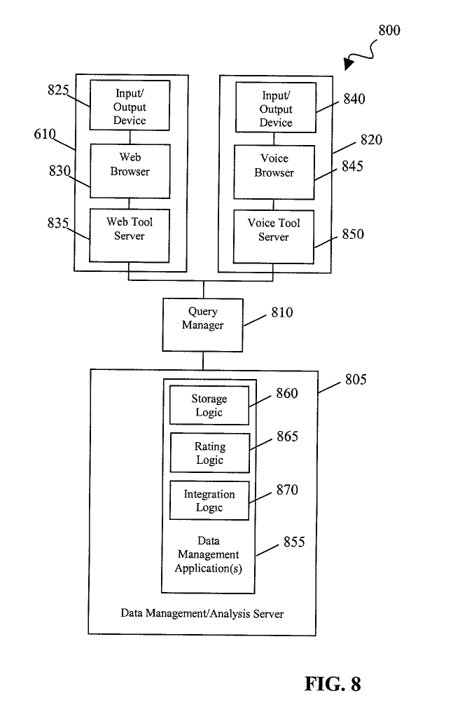

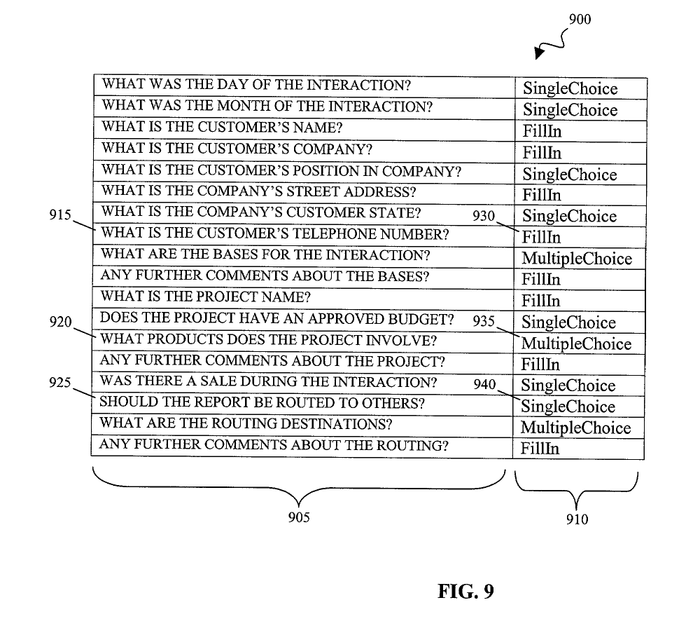

Referring to FIG. 8, an example system 800 for gathering data includes a backend data management/analysis server 805, a query manager 810, a front end Web data gathering form server 610, and a front end voice data gathering form server 820. Web form server 610 includes data input/output devices 825, a Web browser 830, and a Web server 835. Voice form server 820 includes data input/output devices 840, a voice browser 830, and a voice server 835. Query manager 810 manages data exchange between form servers 610, 820 and data management/analysis server 805.

Data management/analysis server 805 may be, for example, a central database system that includes a data management application 855. Data management application 855 includes storage logic 860 for storing and accessing data, rating logic 865 for evaluating data, and integration logic 870 for integrating with other applications. Data management application 855 may be a customer resource management (CRM) application such as SAP™ CRM 3.0.

In an example operation, a responder places a telephone call from a phone (i.e., an input/output device 840) on a public telephone network. The telephone call is redirected from the gateway to voice server 850. Voice server 850 creates a voice browser 845 and forwards the call to query manager 810. Query manager 810 identifies the responder using, for example, a password and authorizes data transactions with the incoming call. Query manager 810 also requests a relevant data gathering form from data management/analysis server 805 and identifies that the responder intends to use voice browser 845 to respond.

Data management/analysis server 805 identifies a relevant data gathering form using, for example, the identification provided by the responder, and splits and transforms the form. Data management/analysis server 805 transmits the relevant data gathering form values 215 through query manager 810 to voice survey server 850. Since the responder's platform is the telephone, data management/analysis server 805 also prepares and transmits a data gathering form template for voice 210. Voice survey server 850 renders the voice template and values employing voice browser 845 to present the queries to the responder using a speaker (i.e., an input/output device 840).

The responder replies to the queries using, for example, a keypad or by speaking into a telephone microphone (i.e., input/output device 840). Spoken replies can be analyzed using voice recognition software. The replies are received by voice browser 845, which sends the responses to query manager 810. Query manager 810 forwards the responses, along with session information, to data management/analysis server 805. Data management/analysis server 805 stores the responses in data gathering form values 215, as discussed above. Data management/analysis server 805 may also analyze or otherwise process the responses as appropriate. Data management/analysis server 805 may integrate the responses into other applications using integration logic 870. After the voice session is complete, voice server 850 ends the voice browser 845.

If the responder does not respond to every query in the data gathering form, the responder can also log on to a website on Web form server 835 using Web browser 830. Query manager 810 again identifies the responder and authorizes data transactions. Query manager 810 also requests the partially-completed data gathering form from data management/analysis server 805, and identifies that the responder intends to use Web browser 830 to respond.

Data management/analysis server 805 identifies the partially-completed data gathering form and splits and transforms the form. Data management/analysis server 805 transmits the data gathering form values 215 through query manager 810 to Web form server 835. Since the responder's platform employs Web browser 830, data management/analysis server 805 also prepares and transmits a data gathering form template for HTML 210. Web form server 835 renders the HTML template and form values to present the queries to the responder using Web browser 830 running on, for example, the responder's personal computer (i.e., input/output device 825).

The responder's replies are received by Web browser 830, which relays the responses to query manager 810. Query manager 810 forwards the responses, along with session information, to data management/analysis server 805. Data management/analysis server 805 stores the responses in data gathering form values 215.

A customer interaction report is another class of data gathering form. In general, customer interaction reports include queries that identify a customer (or a potential customer) and describe the nature of a particular interaction with the customer. The interaction can be, for example, a telephone call, a sales visit, a service visit, or an email exchange. Customer interaction reports are commonly completed by a salesperson, an account manager, a service engineer, or another individual who responds to the queries in the report to create a record of the interaction with the customer.

Referring to FIG. 9, an example interaction report 900 includes a collection of queries 905 and a corresponding collection of responses 910. For the sake of convenience, queries in collection 905 are denoted only by query text and the responses in collection 910 are denoted by the type of response requested by the corresponding query, rather than the text of the potential responses. Collection of queries 905 includes individual queries 915, 920, and 925, for example, directed to identifying the customer and the nature of the interaction with the customer. For example, query 915 is directed to identifying the telephone number of the customer, query 920 is directed to identifying particular products that may be involved in a project, and query 920 is directed to identifying whether the information in interaction report 900 should be distributed to others. Collection of responses 910 includes individual responses 930, 935, and 940 to queries 915, 920, and 925. Responses 930, 935, and 940 fall within certain response types. For example, query 915 requests a “FillIn” response 930 identifying the customer's telephone number, query 920 requests a “MultipleChoice” response 935 identifying one or more products from the product line that may be involved in a project of the customer, and query 925 requests a “SingleChoice” response 940 identifying whether or not the interaction report should be routed to others.

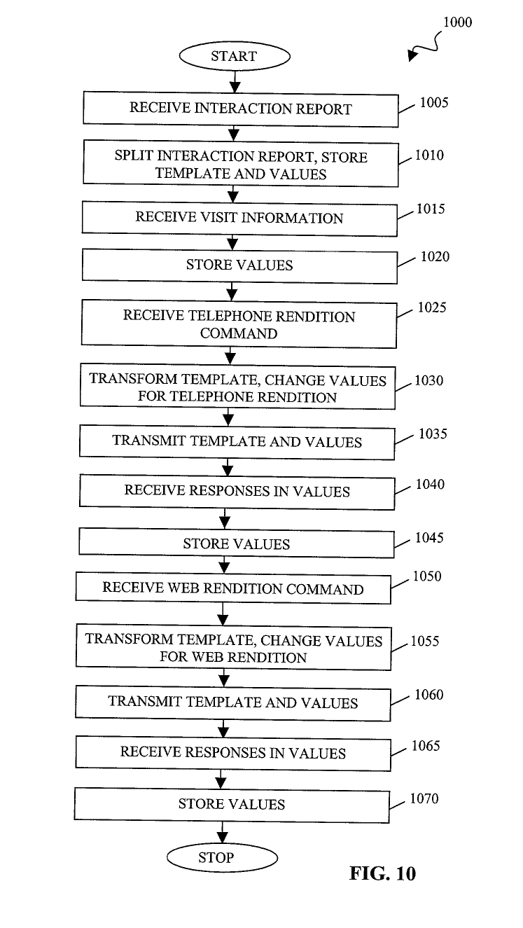

Referring to FIG. 10, a process flow 1000 by which an interaction report, such as interaction report 900, may be completed involves a scheduled visit between a salesperson or other user and a customer. A system for gathering data receives a generic interaction report (step 1005) and splits the interaction report to create and store an interaction report template and interaction report values (step 1010), as discussed above.

The system for gathering data also receives information about the scheduled visit between the salesperson and the customer (step 1015). The visit information may include the identity of the customer, a time and date of the visit, the expected location, and a reason that the visit is scheduled at this time. For example, the visit information may identify that a routine visit at the start of a new fiscal year for a large widget manufacturer is scheduled, that the visit is to occur on the second Tuesday in October at a widget manufacturing plant, and that the salesperson is to meet with the director of manufacturing.

The system for gathering data may use the received visit information to assign responses to certain queries within the interaction report. For example, the system for gathering data may access another database to determine the telephone number of the director of manufacturing and use the determined telephone number as the value of response 930. This “prepopulates” the interaction report values with responses that are stored by the system for gathering data (step 1020).

On the second Tuesday in October, the salesperson may dutifully show up at the widget manufacturing plant only to discover that the director of manufacturing has taken ill and is unavailable, but that the associate director of manufacturing is available to meet. The salesperson meets the associate director, receives the associate director's business card, and discusses the widget manufacturer's plans for a project to develop improved widgets. The associate director describes the technical requirements of equipment for the widget development project and asks about products in the salesperson's line that meet those technical requirements. The salesperson is uncertain if certain products meet the requirements, and promises to have an application engineer contact the associate director to discuss this issue.

Shortly after the visit, and typically before the salesperson is back at the office, the salesperson can start responding to the queries in an interaction report by placing a telephone call to the system for gathering data, logging in, and asking to complete the prepopulated interaction report. As described above, the system receives the rendition command indicating that rendition of the prepopulated interaction report over the telephone is requested (step 1025). The system transforms the interaction report template and changes the interaction report values (step 1030) for vocalization, and transmits the transformed template and the changed values to a voice server that controls the session with the salesperson's telephone (step 1035).

The voice server integrates the interaction report template and the interaction report values into a single telephone interaction report. Queries in the interaction report are vocalized by the voice server over the salesperson's telephone. The voice server in turn receives responses to the queries when, for example, the salesperson strikes the appropriate keys on a telephone keypad or speaks into the telephone microphone.

When the voice server vocalizes query 915 asking about the customer's telephone number, the salesperson realizes that the current response in the interaction report values is the director of manufacturing's number and not the associate director's. The salesperson recalls having received the associate director's business card and starts searching pockets and briefcase in an attempt to locate the card and the associate director's phone number. The salesperson may decide to skip query 915, and may indicate this to the voice server. The salesperson responds to additional queries in the interaction report, and eventually reaches query 920, after which the telephone session may end.

When the telephone session has been ended, the voice server returns the salesperson's responses, including the decision to skip query 915, in the interaction report values to the system for gathering data. The system for gathering data receives the responses in the updated interaction report values (step 1040) and stores the updated values (step 1045) that partially complete the interaction report.

When the salesperson later returns to the office and has access to a computer, the salesperson uses a web browser or email application on the computer to log into a computer system. The logon can automatically trigger the transmission of a web rendition command to the system for gathering data, or transmission of a web rendition command can be triggered when the salesperson specifically asks to complete the partially completed interaction report. In either case, the system for gathering data receives the web rendition command (step 1050), transforms the interaction report template, and changes the interaction report values for web rendition (step 1055). The interaction report values include the responses previously provided by the salesperson over the telephone.

The system for gathering data transmits the interaction report template and values to the web browser (step 1060). The web browser integrates the interaction report template and the interaction report values into a single interaction report. Queries in the interaction report are rendered by display on the monitor of the computer. The web server receives responses to the queries when the salesperson keys in the response or selects the responses using the computer's mouse.

Among the queries rendered by the web browser is query 915 that requests the telephone number of the associate director. The salesperson is able to turn away from the computer, place the briefcase on the desk, and rifle through the briefcase to locate the associate director's business card. After locating the card, the salesperson proceeds to key in the associate director's telephone number to respond to query 915. Web browser proceeds to render query 920, where the salesperson had left off upon arriving at the office.

Queries can thus be presented to the salesperson responder out of turn. Moreover, the ordering of the queries can be determined by the nature of the query, the nature of the platform, or the nature of the required response. For example, queries requesting a “FillIn” response may be difficult to respond to using the telephone. Likewise, different personnel may have different expertise that is useful in responding to different queries, as discussed further below.

When the salesperson has completed the interaction report, the web server returns the salesperson's responses in the interaction report values to the system for gathering data. The system for gathering data receives the responses in the updated interaction report values (step 1065) and stores the updated values (step 1070) that complete the interaction report.

The salesperson may complete the interaction report over multiple sessions, if needed. For example, the salesperson may complete a second portion of the interaction report on the day of the visit, but complete the interaction report a day later in a third session.

The system for gathering data may also prepare the completed interaction report for rendition at other destinations. For example, if the salesperson has responded positively to query 925, i.e., the salesperson has affirmed that the interaction report should be routed to others, the system for gathering data may prepare the completed interaction report for rendition at the identified destinations. The system for gathering data can also prepare the completed interaction report for default renditions such as, for example, for the salesperson's manager. For example, the salesperson's manager may keep paper copies of all interaction reports. In this case, the system for gathering data transforms the interaction report template and changes the interaction report values for printing. As another example, the salesperson may indicate, in response to a query, that an applications engineer should contact the associate director to identify equipment that addresses the technical requirements of the widget development project. In this case, the system for gathering data transforms the interaction report template and changes the interaction report values for email rendition.

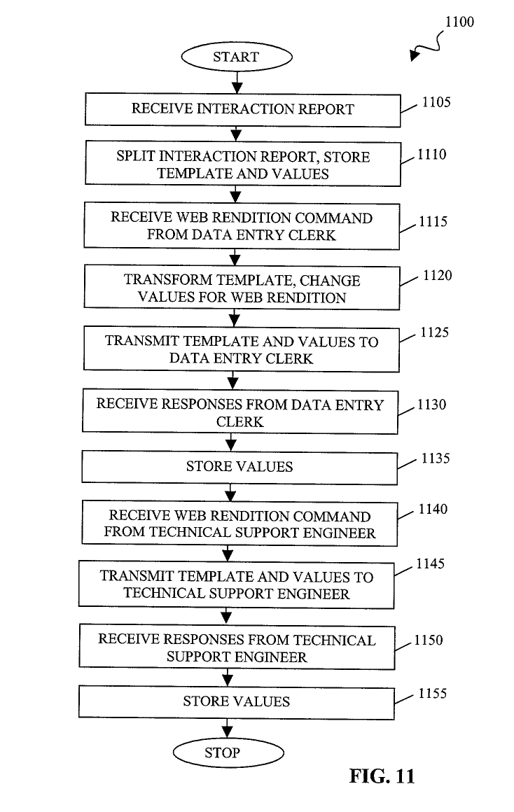

Referring to FIG. 11, another process flow 1100 by which an interaction report may be completed involves a customer telephone call to a technical support help-desk. The technical support help-desk has two tiers. The first tier is staffed by clerical personnel who are responsible for screening calls, obtaining and entering non-technical site and contact information, and appropriately forwarding the call to the second tier. The second tier is staffed by technical support engineers who are responsible for addressing a customer's technical questions and entering details about the technical nature of the call.

A system for gathering data supports both tiers of the help-desk. In particular, the system for gathering data first receives an interaction report that is to include information entered by both the first tier and the second tier of the help-desk (step 1105). The system for gathering data then splits the interaction report to create and store an interaction report template and interaction report values, as discussed above (step 1110).

In response to a customer call, the system for gathering data receives a web rendition command from a computer manned by a clerk in the first tier of the help desk (step 1115), transforms the interaction report template, and changes the interaction report values for web rendition (step 1120). The system for gathering data transmits the interaction report template and values to a web browser used by the data entry clerk (step 1125).

The web browser renders the interaction report for the data entry clerk who proceeds to respond to non-technical queries in the interaction report using information received from the caller. For example, the data entry clerk can enter (or retrieve from a database) information about the site from which the caller is calling, as well as contact information about the caller. The data entry clerk may also enter information about the general nature of the call so that the call can be forwarded to the appropriate technical service engineer in the second tier of the help desk. By responding to queries of a non-technical nature, the data entry clerk partially completes the interaction report. When the data entry clerk has finished entering information, the data entry clerk instructs the web browser to return the interaction report values to the system for gathering data.

The system for gathering data receives the responses from the data entry clerk in the updated interaction report values (step 1130) and stores the updated values that partially complete the interaction report (step 1135). When the call reaches the appropriate technical support engineer in the second tier, the technical support engineer requests the partially-completed interaction report. The system for gathering data receives the rendition command from a computer staffed by the technical support engineer (step 1140). Since the partially-completed interaction report has already been transformed for web rendition, the system for gathering data simply transmits the interaction report template and updated values to a web browser used by the technical support engineer (step 1145).

The web browser renders the interaction report for the technical support engineer who proceeds to respond to technical queries in the interaction report using information received from the caller. For example, the technical support engineer enters information about the problem that the caller is having and the recommended solutions. Since the technical support engineer does not need to enter responses to the non-technical queries, the technical support engineer's time is saved. When the call is finished and the technical support engineer has finished entering information, the technical support engineer instructs the web browser to return the interaction report values to the system for gathering data. The system for gathering data receives the responses from the technical support engineer in the updated interaction report values (step 1150) and stores the updated values (step 1155).

The interaction report can be rendered for other users using different platforms. For example, it may be necessary that a field service engineer visit the caller's site to address the problem that prompted the call. The system for gathering data may split the interaction report to create and store an interaction report template for rendering the interaction report on the field service engineer's PDA.

The described systems and techniques can be implemented in digital electronic circuitry, in computer hardware, firmware, or software, or in combinations of these. Systems can be implemented in a computer program product tangibly embodied in a machine-readable storage device for execution by a programmable processor; and method steps of the described techniques can be performed by a programmable processor executing a program of instructions to perform functions by operating on input data and generating output. The systems and techniques can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. The essential elements of a computer are a processor for executing instructions and a memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (“application-specific integrated circuits”).

To provide for interaction with a user, the systems and techniques can be implemented on a computer system having a display device such as a monitor or a LCD screen for displaying information to the user, and a keyboard and a pointing device such as a mouse or a trackball by which the user can provide input to the computer system. The computer system can be programmed to provide a graphical user interface through which computer programs interact with users.

A number of implementations have been described. Nevertheless, it will be understood that various modifications may be made. For example, data gathering forms with other formats such as standard generalized markup language (SGML) formats may be used.

Accordingly, other implementations are within the scope of the following claims.

What is claimed is:

1. A computer-implemented method of filling out an electronic data gathering form, the method comprising:
presenting, during a first session of filling out the data gathering form, a series of queries to a user;
receiving from the user, during the first session, voice responses to the presented queries;
presenting on a visual display, during a later second session of filling out the data gathering form, content of the voice responses received from the user; and
permitting responses to other queries of the data gathering form to be filled out using an input device associated with the visual display.

2. The method of claim 1, wherein the electronic data gathering form comprises a customer interaction report concerning an interaction with a customer.

3. The method of claim 2, wherein the customer interaction report concerns a sales visit with the customer.

4. The method of claim 1, wherein presenting the series of queries to the user comprises vocalizing the series of queries to the user.

5. The method of claim 4, wherein vocalizing the series of queries comprises vocalizing the series of queries over a telephone network.

6. The method of claim 5, wherein receiving the voice responses to the vocalized queries comprises receiving the voice responses over the telephone network.

7. The method of claim 1, further comprising receiving user responses completing the electronic data gathering form in the second session.

8. The method of claim 1, wherein presenting the electronic data gathering form on the visual display comprises presenting the electronic data gathering form at a first time the user logs into a computer system associated with the visual display after the user provides the voice responses.

9. The method of claim 1, wherein the user does not complete filling out of the electronic data gathering form in the second session.

10. The method of claim 9, further comprising presenting, during a later third session of filling out the data gathering form, the electronic data gathering form having responses completed using the voice responses and the second session responses from the user.

11. The method of claim 9, further comprising receiving responses from a second user during the second session.

12. A computer program product, tangibly stored on machine readable media, for filling out an electronic data gathering form, the product comprising instructions to cause a processor to:
receive a first response to a first query in an interaction report over a first platform, the interaction report relating to an interaction with a customer;
receive a second response to a second query in the interaction report over a second platform, the second platform being different from the first platform; and
store the first response in association with the second response in an electronically-accessible format.

13. The product of claim 12, wherein the first response and the second response are received from a single person.

14. The product of claim 13, wherein the first response and the second response are received from a salesperson to report about a visit with the customer.

15. The product of claim 13, wherein the instructions cause the processor to receive the first response over a telephone.

16. The product of claim 13, wherein the first response can be used to determine a likelihood that the customer will purchase a product.

17. The product of claim 16, wherein the instructions cause the processor to determine the likelihood that the customer will purchase the product.

18. The product of claim 12, wherein the first response can be used to determine if the interaction report should be routed to another.

19. The product of claim 18, wherein the instructions cause the processor to route the interaction report as directed by the first response.

20. The product of claim 19, wherein the instructions cause the processor to:
identify a format-independent portion of the interaction report and a format-dependent portion of the interaction report, the format-independent portion including the first response and the second response; and
transform the format-dependent portion of the interaction report for rendition.

21. The product of claim 12, wherein the first response identifies the customer in the interaction.

22. The product of claim 12, wherein the instructions cause the processor to store the first response and the second response separately from the first query and the second query.

23. The product of claim 12, wherein the instructions cause the processor to:
identify a format-independent portion of the first query and a format-dependent portion of the first query, the format independent portion including the first response; and
transform the format-dependent portion of the first query for rendition on the first platform.

24. The product of claim 12, wherein the instructions cause the processor to store the first response and the second response as a format-independent portion of the interaction report.

25. The product of claim 24, wherein the instructions cause the processor to store a format-dependent portion of the interaction report.

26. The product of claim 12, wherein the instructions cause the processor to store the interaction report in a XML format.

27. The product of claim 12, wherein the instructions cause the processor to order the first query before the second query.

28. The product of claim 27, wherein the instructions cause the processor to order the first query before the second query based on a nature of the first platform.

29. The product of claim 27, wherein the instructions cause the processor to order the first query before the second query based on a nature of the first query.

30. The product of claim 27, wherein the instructions cause the processor to order the first query before the second query based on a nature of the first response.
